(19) United States
(12) Patent Application Publication
(10) Pub. No.: US 2024/0061699 A1
(43) Pub. Date: Feb. 22, 2024

(54) SECURING CONTENT FROM GUEST VIRTUAL MACHINES FROM UNAUTHORIZED ACCESS BY HOST OPERATING SYSTEMS

(71) Applicant: NVIDIA Corporation, Santa Clara, CA (US)

(72) Inventors: Lucien Dunning, Ramsey, NJ (US); Subhash Gutti, Milpitas, CA (US); Rudi Bloks, Sunnyvale, CA (US); Harish Chander Rao Vutukuru, San Jose, CA (US); Naresh Kumar Mankala, Hyderabad (IN); Vijay Kumar Thirkovluru, Manikonda (IN); Aung Oo, Bellevue, WA (US); Arun Swain, San Jose, CA (US)

(21) Appl. No.: 18/110,070

(22) Filed: Feb. 15, 2023

Related U.S. Application Data
(60) Provisional application No. 63/399,112, filed on Aug. 18, 2022.

(51) Int. Cl. G06F 9/455

(52) U.S. Cl. CPC G06F 9/45558; G06F 2009/45595; G06F 2009/45587

(57) ABSTRACT

In examples, a virtual channel allocated to a virtual machine may be used to transmit image data representing a display surface to memory assigned to the display surface in a virtual address space of the virtual machine. A physical display engine may be configured to fetch the image data from the memory, perform desired transformations, and send the resulting output to the display surface to display. Privileged software may process requests from virtual machines for allocations or configurations of display surfaces and configure the physical display engine, a memory system, and/or other system components accordingly. Software running on a virtual machine may use virtual channels to submit the requests and transmit image data for display surfaces to memory using the virtual address space. A virtual channel may be provided by a virtual network adapter assigned to the virtual machine.

### CROSS-REFERENCE TO RELATED APPLICATIONS

This application claims the benefit of U.S. Provisional Application No. 63/399,112, filed on Aug. 18, 2022, which is hereby incorporated by reference in its entirety.

### BACKGROUND

Hardware-assisted virtual machines have been used to facilitate multiple guest operating systems (OSes) running in isolation on the same underlying hardware. A device supporting virtualization may allow multiple virtual devices to operate as sub-instances of the device. Each virtual device may be directly exposed to a guest OS while operating as a bare-metal device for performance. Virtualization solutions may enable multiple guest OSes to share the same display hardware.

Typically, a desktop composition software application running on a host OS of the device combines rendered surfaces from the guest OSes into a composite surface and provides the composite surface to a display engine of the device. This approach does not allow for isolation or protection of a rendered surface from other guest OSes or the host OS, which may cause security risks. A conventional approach may be used to provide a guest OS with an isolated scan-out path. In this approach, an individual GPU or individual display engine is completely exposed directly to the guest OS as a pass-thru device via an input—output memory management unit (IOMMU). However, a physical device is required for each guest OS so that multiple physical devices are needed, which may be computationally inefficient. Further, multiple virtual machines and guest OSes are unable to share the same display monitor.

### SUMMARY

Embodiments of the present disclosure relate to virtual display engines for virtual machines. In particular, the disclosure relates to approaches for providing a virtual display engine(s) having an isolated scan-out path(s) for rendered surfaces through a physical display engine(s). Disclosed approaches may be used to allow guest OSes and/or a host OS to share the same display monitor with other OSes while using isolated scan-out paths. According to one or more embodiments, content from guest OSes can be directly displayed without performance overhead and without exposing content to the host OS corresponding to a physical display. By preventing the content from being exposed to the host OS, the content from the guest OSes can be assured to be free from unauthorized and unfair modification or augmentation, such as for competitive or spectated gaming and other applications that emphasize unassisted performance, or in sandboxed environments.

In contrast to conventional approaches, such as those described above, disclosed approaches may use a virtual channel(s) allocated to a virtual machine to transmit image data representing a display surface(s) to memory assigned to the display surface(s) in a virtual address space(s) of the virtual machine. A physical display engine may be configured to fetch the image data from the memory in the virtual address space and scan-out a surface corresponding to the display surface(s) to a display. Privileged software (e.g., software with pre-existing or pre-established authorization and access levels) may process requests from virtual machines for allocations or configurations of display surfaces and configure the physical display engine, a memory system, and/or other system components accordingly. Software running on a virtual machine (e.g., a kernel mode display driver) may use a virtual channel to submit the requests and transmit image data for display surfaces to memory using the virtual address space. At least one of the virtual channels may be provided by a virtual network adapter(s) assigned to the virtual machine, an example of which includes a virtual function of peripheral component interconnect express (PCIe).

### BRIEF DESCRIPTION OF THE DRAWINGS

The present systems and methods for virtual display engines for virtual machines are described in detail below with reference to the attached drawing figures, wherein:

FIG. 1 depicts an example of a surface display system, in accordance with some embodiments of the present disclosure;

FIG. 2 illustrates an example of a virtual function and software of a virtual machine which may be used to implement a surface display system, in accordance with some embodiments of the present disclosure;

FIG. 3 is a flow diagram showing a method a virtual machine may use for receiving an allocation of a display surface and scan-out a corresponding surface, in accordance with some embodiments of the present disclosure;

FIG. 4 is a flow diagram showing a method privileged software may use for facilitating a virtual machine scanning out a surface, in accordance with some embodiments of the present disclosure;

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

The present disclosure relates to virtual display engines for virtual machines. In particular, the disclosure relates to approaches for providing a virtual display engine(s) having an isolated scan-out path(s) for rendered surfaces through a physical display engine(s). Disclosed approaches may be used to allow a guest OS(es) and/or a host OS to share the same display monitor with other OSes while using isolated scan-out paths.

Disclosed approaches may use a virtual channel(s) allocated to a virtual machine to transmit image data representing a display surface(s) to memory assigned to the display surface(s) in a virtual address space(s) of the virtual machine. A physical display engine may be configured to fetch the image data from the memory using the virtual address space and scan-out a surface corresponding to the display surface(s) to a display. Using virtual address spaces to provide isolated scan-out paths for virtual machines may allow multiple virtual machines may share the same physical display engine. Further, the physical display engine may composite a display surface(s) from each virtual machine, thereby isolating the display surfaces from the host OS.

In at least one embodiment, a display surface(s) may be allocated to a virtual machine(s) using privileged software, such as trusted microcode and/or a privileged virtual machine. For example, the privileged software may process requests from virtual machines for allocations of display surfaces to the virtual machines. The privileged software may (e.g., responsive to a request for an allocation), for example, configure one or more of a physical display engine to fetch image data representing a display surface(s) from memory using a virtual address space of a virtual machine, raster timings the physical display engine uses to scan-out a surface corresponding to the display surface(s), or a resolution the physical display engine uses to scan-out the surface.

In at least one embodiment, software of a virtual machine, such as a kernel mode driver (e.g., a kernel mode display driver) may request an allocation of a display surface(s) over a virtual channel(s) of the virtual machine that is used by the privileged software to control and/or configure the physical display engine and the kernel mode driver for display of a surface. The software may use another virtual channel of the virtual machine as an isolated scan-out path for one or more allocated display surfaces. In one or more embodiments, at least one of the virtual channels may be provided by a virtual network adapter(s) assigned to the virtual machine. For example, at least one of the virtual channels may correspond to a virtual function(s) of peripheral component interconnect express (PCIe).

Disclosed approaches may provide a secure means to scan-out content from within a guest OS with little to no performance impact while still providing display features such as G-SYNC, virtual reality, hardware tone-mapping, etc. to a virtual machine. Such high-performance may be particularly suitable for enabling scenarios such as gaming within a virtual machine, and/or anti-cheat, where a game may run within a validated secured guest OS.

Disclosed approaches may further be used for scenarios where any sandboxed/containerized applications need to directly present to display hardware for performance reasons or to ensure and validate the link integrity before rendering. Examples of such scenario include secure video decoding or game streaming services running within a sandboxed module to ensure secured, performant and light-weight execution of client applications.

Disclosed approaches may further be used for automotive use cases where avoiding interference across multiple virtual machines may be desirable. Disclosed approaches may provide isolation at the same level as an independent physical display engine assigned to different software components running within a virtualized environment to drive the display.

Some display engines have a write-back path where a composited surface can be written to a memory location instead of scanning out to a monitor. In server-based streaming desktop scenarios, such as Virtual Desktop Infrastructure (VDI) or game-streaming, which may use multiple display-based overlays, a write-back resource can be assigned to a virtual display engine. Assigning the write-back resource may allow a full composited image to be streamed, thus, allowing the same end-user experience as on a physical monitor.

The systems and methods described herein may be used for a variety of purposes, by way of example and without limitation, these purposes may include systems or applications for machine control, machine locomotion, machine driving, synthetic data generation, model training, perception, augmented reality, virtual reality, mixed reality, robotics, real-time data streaming, security and surveillance, autonomous or semi-autonomous machine applications, deep learning, environment simulation, data center processing, conversational AI, light transport simulation (e.g., ray tracing, path tracing, etc.), collaborative content creation for 3D assets, digital twin systems, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for generating or maintaining digital twin representations of physical objects, systems implemented at least partially using cloud computing resources, and/or other types of systems.

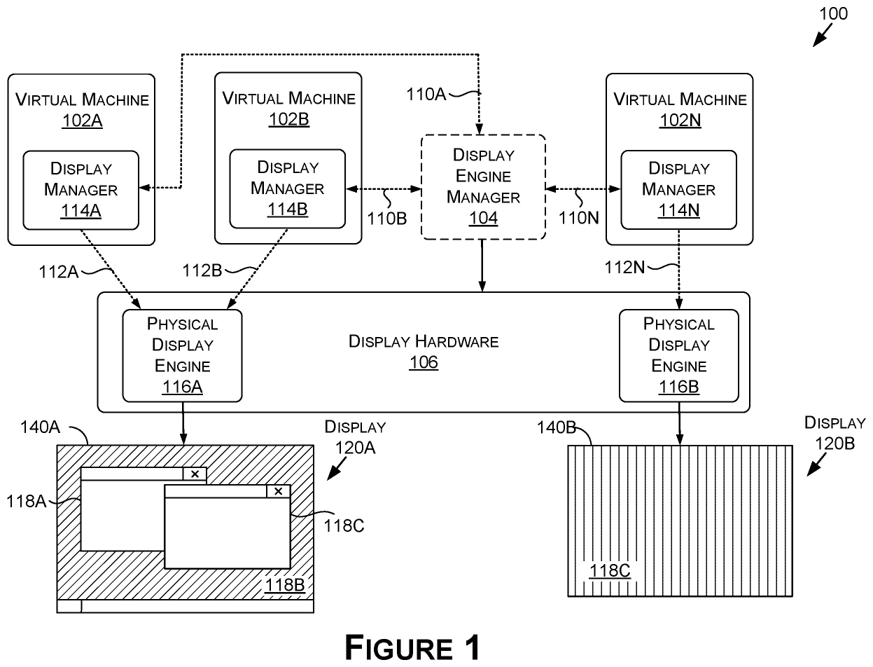

FIG. 1 depicts an example of a surface display system 100 (also referred to herein as “system 100”), in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The system 100 may be implemented using, among additional or alternative components, one or more virtual machines, such as virtual machine 102A and a virtual machine 102B through a virtual machine 102N (which may be referred to as “virtual machines 102”), a display engine manager 104, and display hardware 106.

As an overview, each virtual machine 102 may be allocated one or more virtual channels, such as a virtual channel 110A and a virtual channel 112A allocated to the virtual machine 102A, a virtual channel 110B and a virtual channel 112B allocated to the virtual machine 102B, and a virtual channel 110N and a virtual channel 112N allocated to the virtual machine 102N. The virtual channels 110A, 110B, and 110N (also referred to as “virtual channels 110”) may be used by the virtual machines 102 to request allocations of display surfaces (and/or display windows) and/or receive data corresponding to allocated display surfaces from the display engine manager 104. The display engine manager 104 may be configured to use the virtual channels 110 to receive the requests, perform at least a portion of the allocations, provide data indicating the allocations to the virtual machines 102, and/or configure one or more of a physical display engine 116A or a physical display engine 116B (also referred to as “physical display engines 116”) of the display hardware 106 to fetch the allocated display surfaces and scan-out surfaces 140A or 140B (also referred to as “surfaces 140”) corresponding to the allocated display surfaces for presentation on a display 120A or a display 120B. The virtual channels 112A, 112B, and 112N (also referred to as “virtual channels 112”) may be used by the virtual machines 102 to transmit image data representing the display surfaces to memory assigned to the display surfaces in virtual address spaces of the virtual machines 102. The physical display engines 106 may be configured (e.g., by the display engine manager 104) to fetch the image data from the memory using the virtual address spaces and scan-out corresponding surfaces to the display 120A and/or the display 120B (also referred to as “displays 120”).

In various embodiments, the display hardware 106 may include one or more devices, each having one or more physical display engines, which may also be referred to as one or more physical display heads. For example, the display hardware 106 may include a fixed number of physical display engines, which may define a maximum number of displays 120 that can be independently driven by the display hardware 106 at any given time. An example of the display hardware 106 includes one or more graphics processing units (GPUs). In one or more embodiments, a physical display engine 116 may be implemented as fixed-function hardware (e.g., register-transfer level coded hardware).

A physical display engine 116 may be configured (e.g., by the display engine manager 104 using one or more virtual channels 110) to physically drive a display 120 connected to the physical display engine 116. A physical display engine 116 may include a fetch engine and a scan-out engine. The fetch engine may be configured (e.g., by the display engine manager 104 using one or more virtual channels 110) to fetch and/or receive (e.g., asynchronously), from memory corresponding to one or more virtual machines 102, image data representing one or more of the display surfaces used to scan-out a surface 140. Driving the display 120 may include the scan-out engine of the physical display engine 116 generating display timings or signals sent to the display 120 (e.g., as an image stream) for presentation of a surface 140. The display timings may be generated in accordance with a resolution and refresh rate for the display 120, which may be configurable (e.g., by the display engine manager 104 using one or more virtual channels 110) in at least one embodiment. As a non-limiting example, a physical display engine 116 may be configured to generate display timings in accordance with a 1080P display resolution and 60 Hz refresh rate.

The fetch engine may be configured (e.g., by the display engine manager 104 using one or more virtual channels 110) to receive the image data for the scan-out engine in accordance with the display timings (e.g., at a constant rate define by the refresh rate). Thus, for a 60 Hz refresh rate, the physical display engine 116A may fetch image data representing one or more display surfaces from memory corresponding to the virtual machine 102A and image data representing one or more display surfaces from memory corresponding to the virtual machine 102B 60 times per second with additions of any other timings, such as vertical intervals or VBLANKS.

In one or more embodiments, a physical display engine 116 may include a protocol conversion engine. The protocol conversion engine may be configured (e.g., by the display engine manager 104 using one or more virtual channels 110) to convert data corresponding to a surface to a display format that is compatible with a display port protocol used by the display 120. For example, if the display port uses a High-Definition Multimedia Interface (HDMI), the protocol conversion engine may convert the data to an HDMI compatible format. Other non-limiting examples of interfaces include DisplayPort (DP), Display Serial Interface (DSI), Video Graphics Array (VGA), Digital Visual Interface (DVI), or Flat Panel Display Link (FPD-Link).

In one or more embodiments, a physical display engine 116 may include a surface composition engine. The surface composition engine may be configured (e.g., by the display engine manager 104 using one or more virtual channels 110) to composite different display surfaces to generate a surface 140 for scan-out to a display 120. For example, the physical display engine 116A may generate the surface 140A as a composite of one or more display surfaces from the virtual machine 102A and one or more display surfaces from the virtual machine 102B. By way of example, a region 118A and a region 118B of the surface 140A composited by the physical display engine 116A may correspond to display surfaces from the virtual machine 102A. The region 118A may correspond to, for example, a display window of a host OS running on the virtual machine 102A, and the region 118B may correspond to, for example, a desktop of the host OS. By further way of example, a region 118C (a full-screen region) from the physical display engine 116A may correspond to a display surface from the virtual machine 102B. The region 118C may correspond to, for example, a display window of a guest OS to the host OS, with the guest OS running on the virtual machine 102B.

Disclosed approaches may be used to allow the virtual machines 102A and 102B to share the physical display engine 116A while having isolated scan-out paths for display surfaces. Disclosed approaches may also be used to allow the virtual machines 102N to use the physical display engine 116B while allowing one or more other virtual machines 102 to use the physical display engine 116A, where not possible to physically map different virtual machines 102 to different physical display engines 116 of the same display hardware 106 (e.g., due to interleaving of physical display engine registers or otherwise).

FIG. 1 also shows an example where the physical display engine 116B may scan-out the surface 140B without using a surface composition engine. For example, the physical display engine 116B may not include a surface composition engine or may not use an included surface composition engine. In the example shown, a region 118C of the surface 140B may be a full-screen region corresponding to a display surface allocated to the virtual machine 102N.

In one or more embodiments, a physical display engine 116 may include an image conversion engine. In one or more embodiments, at least some of the operations performed by the image conversion engine may be performed on a composed image generated using the surface composition engine. The image conversion engine may be configured (e.g., by the display engine manager 104 using one or more virtual channels 110) to scale and/or rotate one or more display surfaces and/or composed surfaces. Scaling may include upscaling and/or downscaling one or more images, for example, to match the display resolution selected for a display 120. Additionally, or alternatively, the image conversion engine may be configured (e.g., by the display engine manager 104 using one or more virtual channels 110) to perform color space conversion and/or color scaling or adjustment on one or more display surfaces and/or composed surfaces, for example, to match a display profile selected for a display 120.

As described herein, to scan-out a surface 140, a physical display engine 116 may fetch and/or receive, from memory corresponding to one or more virtual machines 102, image data representing one or more of the display surfaces used to scan-out the surface 140. In accordance with one or more embodiments, rather than the physical display engine 116 fetching and/or receiving a display surface(s) from memory using a physical address space, the physical display engine 116 may fetch and/or receive the display surface(s) from one or more of the virtual machines 102 over a virtual channel(s) 112 using a virtual address space(s) corresponding to the virtual machine(s) 102. For example, each display surface allocated to a virtual machine 102 (e.g., by the display engine manager 104 using one or more virtual channels 110) may be fetched by a physical display engine 116 from memory using the virtual address space of the virtual machine 102. Thus, for example, each virtual machine 102 may include an isolated scan-out path with respect to other virtual machines 102 and/or physical display engines 116. For example, where the virtual machine 102A corresponds to a host OS and the virtual machine 102B corresponds to a guest OS of the host OS, display surfaces of each OS may be isolated from one another at generation all the way through scan-out. As such, malicious software running on the host OS may be unable to inspect and/or modify display surfaces from the guest OS.

As described herein, in one or more embodiments, the virtual machines 102 may request allocations of display surfaces (and/or display windows) and/or receive data corresponding to allocated display surfaces from the display engine manager 104. Further, the virtual machines 102 may transmit image data representing the display surfaces to memory assigned (e.g., using the display engine manager 104 using one or more virtual channels 110) to the display surfaces in virtual address spaces of the virtual machines 102. In one or more embodiments, each virtual machine 102 may include a display manager for requesting allocations, receiving the data, and/or transmitting the display surfaces. For example, the virtual machines 102A, 102B, and 102N are shown as including a display manager 114A, a display manager 114B, and a display manager 114N respectively (also referred to as “display managers 114”).

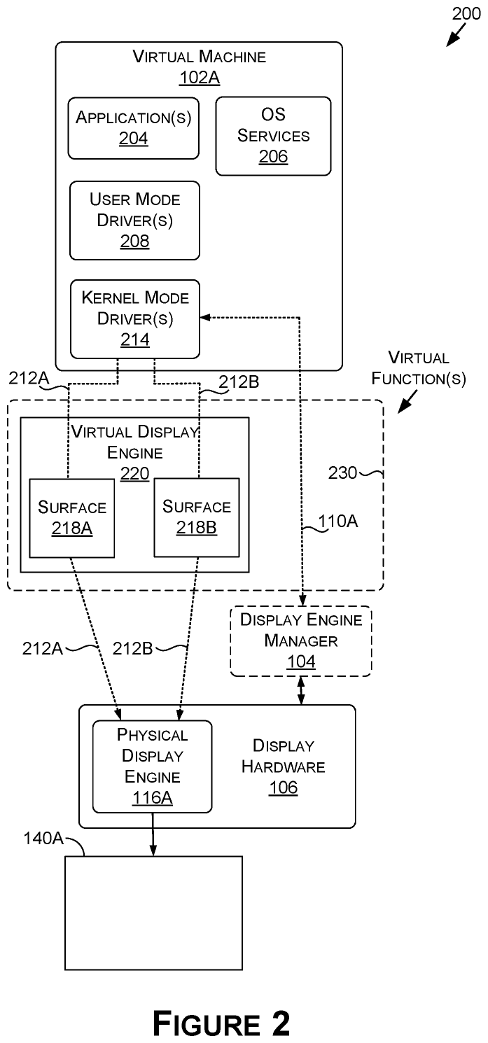

Each display manager 114 may include one or more hardware and/or software components. For example, a display manager 114 may include software loaded on a virtual machine 102. Referring now to FIG. 2, FIG. 2 illustrates an example of a virtual function(s) 230 and software of the virtual machine 102A which may be used to implement a surface display system 200, in accordance with some embodiments of the present disclosure. As indicated in FIG. 2, a display manager 114 may be implemented, at least in part, using one or more drivers installed on a virtual machine 102. For example, the display manager 114A of the virtual machine 102A may be implemented using a kernel mode driver 214. The virtual machine 102A is also shown as including an application(s) 204, OS services 206, and a user mode driver(s) 208. In various embodiments, the display manager 114A may be implemented using one or more of the application(s) 204, the OS services 206, the user mode driver(s) 208, the kernel mode driver(s) 214 and/or other components of the virtual machine 102A.

Examples of the OS services 206 include guest OS services. An example of the application 204 includes a graphics application. In at least one embodiment, an application(s) 204 may present graphics to a graphics Application Programming Interface (API), such as OpenGL or DirectX, which may be implemented as a user mode driver 208. The user mode driver 208 may communicate the graphics through a kernel mode driver 214, which may present the graphics to a virtual display engine 220, rather than the physical display engine 116A using a virtual channel(s). A virtual display engine may a refer to a mechanism that enables graphics data from a virtual machine 102 to be directly provided by the virtual machine 102 to a physical display engine 116 from a virtual address space of the virtual machine 102 (e.g., of a virtual function(s) 230) for scan-out to a display 120 (and optionally any other data exchanged between the virtual machine 102 and the physical display engine 116 to facilitate the scan-out). In at least one embodiment, the mechanism may also enable data from the physical display engine 116 to be directly provided by the physical display engine 116 to the virtual machine 102 using the virtual address space of the virtual machine 102 (e.g., via physical display engine registers). For example, at least some of the data may represent one or more interrupts, VBLANKs, and/or events associated with display of one or more display surfaces.

In the example shown, a virtual channel 212A and a virtual channel 212B may be used, which may correspond to the virtual channel(s) 112A in FIG. 1. For example, the virtual channel 212A may be allocated to a display surface 218A (e.g., corresponding to the region 118A) and the virtual channel 212B may be allocated to a display surface 218B (e.g., corresponding to the region 118B). In one or more embodiments, the kernel mode driver 214 (or more generally a display manager 114) transmits the graphics directly to a virtual function 230 assigned to the virtual display engine 220 (e.g., by the display engine manager 104 using one or more virtual channels 110) using the virtual channel(s) to store the image data representing the display surfaces 218A and 218B in memory using a virtual address space of the virtual machine 102A allocated to the display surfaces 218A and 218B (e.g., allocated to the virtual function 230). For example, each display surface may be allocated a respective portion of the memory. The virtual function 230 is an example of a virtual network interface that may be used to provide one or more virtual channels.

Returning to FIG. 1, a display manager 114 may be configured (e.g., by the display engine manager 104 using one or more virtual channels 110) to transmit image data representing one or more display surfaces to the memory using a virtual address space of a virtual machine 102 for scan-out based at least on the display timings of the corresponding physical display engine 116. One or more virtual memory addresses corresponding to the image data in the virtual address space may be converted or translated to one or more physical memory addresses (e.g., a system physical memory address) in providing the image data to the physical display engine 116. In at least one embodiment, a memory system may perform the translation based at least on (e.g., responsive to) receiving one or more virtual memory identifiers (IDs) of the one or more virtual memory addresses. The memory system may then provide the translated data to the physical display engine 116. In one or more embodiments, the memory system includes a memory management unit (MMU), such as an input-output MMU (IOMMU). In at least one embodiment, virtual memory ID(s) may be provided by the display engine manager 104 to the physical display engine 116 as at least part of allocating memory for a display window (e.g., based on a request from a display manager 114). For example, the display engine manager 104 may request a memory allocation(s) from the MMU and receive data corresponding to the virtual memory ID(s) for the allocated memory. The physical display engine 116 may then use the virtual memory ID(s) to request one or more corresponding display windows.

The display engine manager 104 may be configured to perform, at least in part, any of the various configurations and/or allocations described herein with respect to a physical display engine 116 and/or a virtual machine 102 (e.g., a display manager 114). For example, the display engine manager 104 may be configured to control resource allocations for virtual display engines and/or display surfaces. The display engine manager 104 may control and/or implement one or more of the display timings used by the display manager 114 and the physical display engine 116, window layouts, window or surface positions (e.g., coordinates, display surface resolutions, and/or other parameters of a scan-out path from the display engine manager 104 through a display 120.

In one or more embodiments, the display engine manager 104 may configure the physical display engine to follow the frame rate of frames being scanned from a guest OS. This may allow a display 120 to match the flip-rate of the content generated by the guest OS for latency sensitive features such as variable rate refresh, or virtual, augmented, or mixed reality use-cases for an application running in the guest OS.

In one or more embodiments, the parameters are controlled or implemented at least in part by a host OS or a guest OS using the scan-out path. For example, window or surface positions and depths may be controlled using a window manager of the host OS or supervisor software with elevated privileges.

In one or more embodiments, the display engine manager 104 and/or the host OS may configure ownership of one or more settings or parameters between one or more guest OSes and/or the host OS. For example, ownership of settings may be configured by the host OS to allow either the host OS or a guest OS to control certain parameters or attributes during run time. As non-limiting examples, window depth (e.g., blending order) settings may be controlled by the host OS in a use-case where the guest OS is running within the host OS desktop window manager. In a different use-case, such as where all the windows assigned to a physical display engine 116 belong to a guest OS, the guest OS may need the flexibility to control the window depth settings.

The display engine manager 104 may implement an access control mechanism for features that affect physical display engine attributes (e.g., via rejecting or granting requests). Examples of features include address space association to control which memory accesses are associated with particular display surfaces, which resources from within a physical display engine 116 are associated with a virtual machine 102, etc. The display engine manager 104 may also implement an access control mechanism for features that extend virtual display engine attributes. Examples include features effectuating control by a virtual machine 102 (indirect control via the display engine manager 104) over a position and/or depth of a display surface within a physical display engine 116.

As described herein, a virtual channel(s) 110 may be used by a virtual machine 102 to request an allocation of a display surface(s) and/or window(s). For example, a request may include a request for display resources for a display surface. A virtual channel herein may be implemented as a logical software channel. Each virtual channel may comprise an isolated channel (e.g., facilitating a message queue), which may be provided by a virtual function or other virtual network interface. In at least one embodiment, the virtual channel may be implemented using a device virtualization mechanism such as Intel Virtualization Technology for Directed I/O (VT-d) or AMD IOMMU.

In at least one embodiment, one or more of the virtual channels may be an encrypted virtual channel. The encryption may be provided, for example, by underlying transport encryption. In at least one embodiment, for a virtual channel 112, a display manager 114 may perform encryption/decryption at one end and the display hardware 106 (e.g., a microcontroller of the display hardware 106) may perform encryption/decryption at the other end. Encryption of the virtual channel 112 may be used to protect the image data transported using the virtual channel 112 from being read by an unauthorized entity, such as by using an interposer or other device inserted on the bus. In at least one embodiment, a virtual channel(s) 112 may expose a hardware link connection state that can be cryptographically verified by software running within the guest OS (e.g., by the display manager 114 similar to hardware link connection state verification the host OS may perform). This may allow the guest OS to validate the downstream link integrity, for example, for a High-Bandwidth Digital Content Protection (HDCP) state, to enforce policies for rendering secured content.

Allocating a display surface may include configuring any of a variety of aspects or features to enable a display manager 114 to scan-out of the display surface using a virtual display engine (e.g., to reserve and/or configure display resources, such as hardware resources). By way of example and not limitation, allocation may include one or more of configuring a physical display engine 116 to fetch image data representing the display surface from memory using a virtual address space, configuring display timings the physical display engine 116 uses to scan-out the display surface, configuring a display window the physical display engine 116 associates with the display surface, configuring at least a portion of a virtual channel 112 used to scan-out the display surface, configuring display bandwidth assigned to a virtual machine 102, configuring a resolution the physical display engine 116 uses to scan-out the display surface, configuring a position, location, and/or depth of the display surface with respect to a surface 140 to be scanned-out to a display 120 (and/or one or more other display surfaces), and/or configuring an assignment of the physical display engine 116 to the display surface and/or virtual display engine. While these examples are provided with respect to allocation of a display surface, in one or more embodiments, a request may be made for any of the various configurations (or modifications thereto) at any suitable time after allocation.

Responsive to a request from a virtual machine 102, the display engine manager 104 may use the same or a different virtual channel(s) 110 than what was used to receive the request to provide data indicative of an allocation and/or configuration performed based on the request and/or a result of the request (which may include an error or rejection). Examples include a display surface ID that a display manager 114 may use to further configure and/or alter configurations corresponding to the display surface, and/or one or more configurations of the display surface, such as a resolution, display timings, etc. (e.g., using the virtual channel(s) 110).

In at least one embodiment, the display engine manager 104 may allocate one or more display resources to a guest OS at guest OS creation or initialization time. Examples of allocations of display resources have been described with respect to display surfaces. Further examples of allocations may include allocations of one or more virtual network interfaces, such as the virtual function 230, and/or one or more virtual channels, such as the virtual channels 110 and/or 112. Any violations by the guest OS trying to access resources beyond what is already allocated by the display engine manager 104 (such as trying to scan-out surfaces which need higher bandwidth or accessing surfaces not associated with guest OS) or to change settings that were configured by the display engine manager 104 may result in generation of a violation error interrupt by the hardware that can be handled by the display engine manager 104 upon which a corrective action can be taken based on software policy.

In at least one embodiment, the display engine manager 104 may be implemented, at least in part, on a host OS of the system 100, a hypervisor of the system 100, a privileged virtual machine of the system 100 (e.g., running at a higher privilege than the virtual machines 102), a system management and/or initialization software unit, such as a GPU System Processor (GSP), a trusted microprocessor, and/or using trusted microcode. In one or more embodiments, the display engine manager 104 may be exposed to a CPU through a physical network interface, such as a physical function in PCIe, and that physical network interface may be assigned to a trusted or privileged virtual machine that is responsible for maintaining isolation between virtual network interfaces, such as virtual functions, providing one or more of the virtual channels 112 and/or virtual channels 110.

In at least one embodiment, a virtual machine 102 (e.g., a guest OS) can implement one or more checks that ensure a post-composited image corresponding to a surface 140 being scanned out is as expected and can be notified of any disparities by hardware. In one or more embodiments, a display manager 114 may determine or be notified by interrupts to the virtual machine directly regarding a visual difference between a region in the surface 140 corresponding to a display surface, and an expected region in the surface 140 corresponding to the display surface (e.g., that the region matches the display surface provided by the display manager 114).

In one or more embodiments, to determine a discrepancy, a cyclic redundancy check (CRC) may be generated from the expected surface (e.g., by the display manager 114) and compared to a CRC corresponding to the region in the surface 140 (e.g., generated by the display hardware 106, such as the corresponding physical display engine) to determine whether a discrepancy exists. For example, the CRC may be provided to the display manager 114 over one or more of the virtual channels 112 (or over one or more of the virtual channels 110) for use in performing the comparison. Using disclosed approaches, the display manager 114 may detect or determine the display window is at least partially overlaid by one or more other display surfaces (e.g., based on determining the CRCs do not match). The display manager 114 may perform one or more actions based at least on the determination. For example, the display manager 114 may cause presentation of (e.g., to a user) and/or record (e.g., in a log) whether the regions match. While CRCs are described, any suitable image information may be used for comparison.

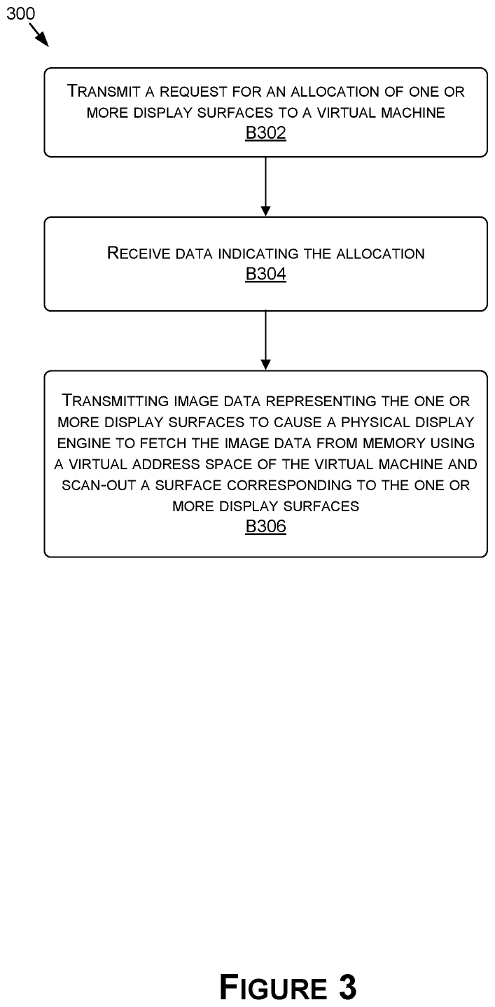

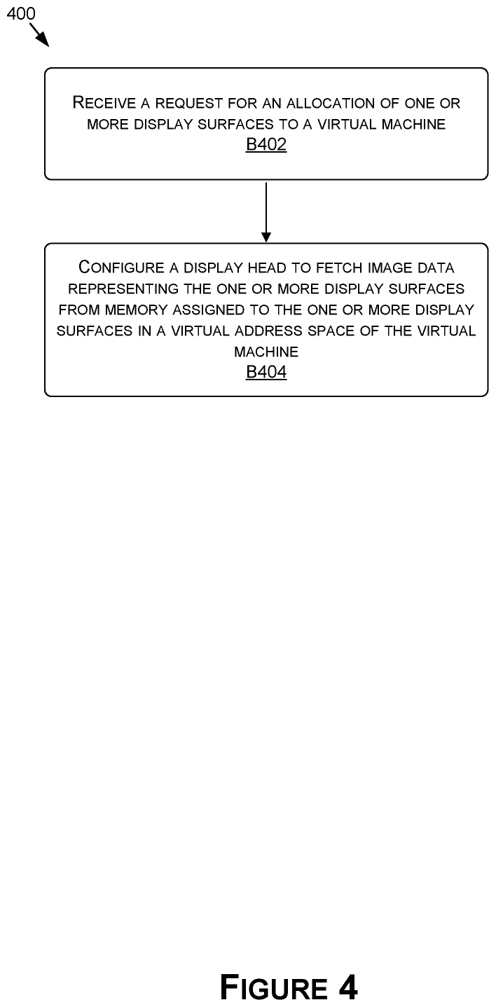

Now referring to FIGS. 3-4, each block of method 300, and 400, and other methods described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods are described, by way of example, with respect to particular figures. However, the methods may additionally or alternatively be executed by any one system, or any combination of systems, including, but not limited to, those described herein.

FIG. 3 is a flow diagram showing a method 300 a virtual machine may use for receiving an allocation of a display surface and scan-out a corresponding surface, in accordance with some embodiments of the present disclosure.

The method 300, at block B302, includes transmitting a request for an allocation of one or more display surfaces to a virtual machine. For example, the display manager 114A may transmit, the virtual channel(s) 110A allocated to the virtual machine 102A, a request for an allocation of the display surface 218A and/or the display surface 218B to the virtual machine 102A.

At block B304, the method 300 includes receiving data indicating the allocation. For example, the display manager 114A may receive, over the virtual channel(s) 110A, data indicating the allocation of the display surface 218A and/or the display surface 218B to the virtual machine 102A.

At block B306, the method 300 includes transmitting image data representing the one or more display surfaces to cause a physical display engine to fetch the image data from memory using a virtual address space of the virtual machine and scan-out a surface correspond to the one or more display surfaces. For example, based at least on the receiving of the data indicating the allocation, the display manager 114A may transmit, over the virtual channel 212A and/or 212B, image data representing the display surface 218A and/or the display surface 218B in a virtual address space of the virtual machine 102A. The transmitting the image data may cause the physical display engine 116A to fetch the image data from the memory using the virtual address space and scan-out the surface 140A corresponding to the display surface 218A and/or the display surface 218B to the display 120A.

Referring now to FIG. 4, FIG. 4 is a flow diagram showing a method 400 privileged software may use for facilitating a virtual machine scanning out a surface, in accordance with some embodiments of the present disclosure. The method 400, at block B402, includes receiving a request for an allocation of one or more display surfaces to a virtual machine. For example, the display engine manager 104 may receive, over the virtual channel(s) 110A allocated the virtual machine 102A, a request for an allocation of the display surface 218A and/or the display surface 218B to the virtual machine 102A.

At block B404, the method 400 includes configuring a physical display engine to fetch image data representing the one or more display surfaces from memory assigned to the one or more display surfaces in a virtual address space of the virtual machine. For example, the display engine manager 104 may, based at least on the receiving of the request, configure the physical display engine 116A to fetch image data representing the display surface 218A and/or the display surface 218B from memory assigned to the display surface 218A and/or the display surface 218B in a virtual address space of the virtual machine 102A.

### Example Computing Device

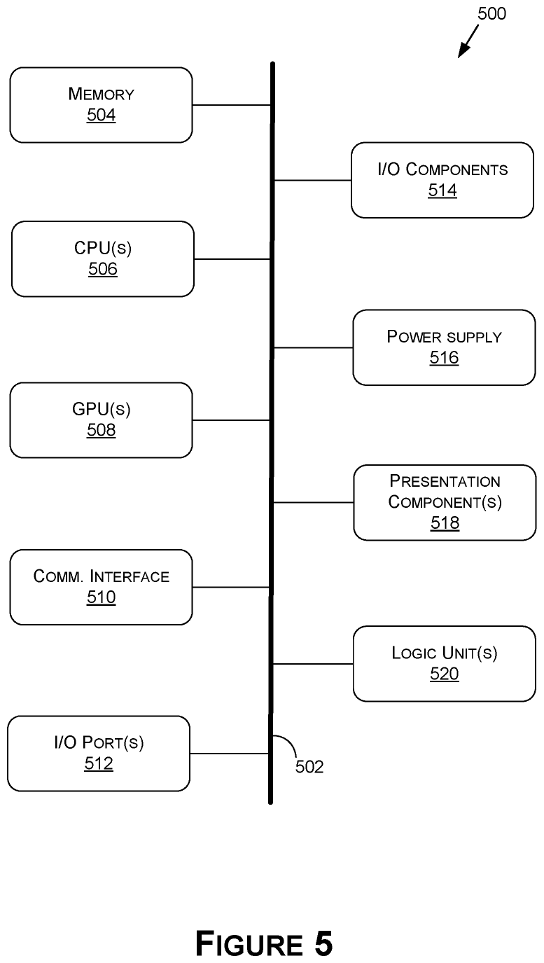

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK, or industry standard or proprietary interconnect buses) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that enable the computing device 500 to communicate with other computing devices via an electronic communication network, included wired and/or wireless communications. The communication interface 510 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may enable the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that enable detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to enable the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### Example Data Center

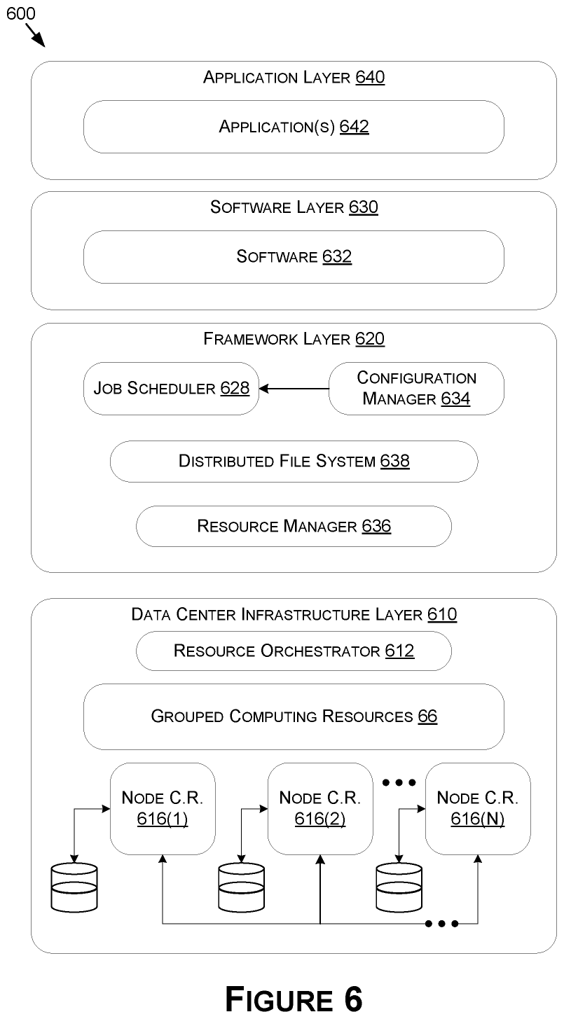

FIG. 6 illustrates an example data center 600 that may be used in at least one embodiments of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may utilize distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
receiving, using one or more virtual channels, data indicating an allocation of one or more display surfaces to a virtual machine;
based at least on the receiving of the data, transmitting, using the one or more virtual channels, image data representing the one or more display surfaces to memory assigned to the one or more display surfaces in a virtual address space corresponding to the virtual machine; and
based at least on the transmitting, causing a physical display engine to fetch the image data from the memory using the virtual address space, and to send a surface corresponding to the one or more display surfaces to a display device.

2. The method of claim 1, wherein the allocation of the one or more display surfaces includes one or more of:
configuring the physical display engine to fetch the image data from the memory using the virtual address space;
configuring one or more raster timings corresponding to the physical display engine to send the surface; or
configuring a resolution corresponding to the physical display engine to send the surface.

3. The method of claim 1, wherein the transmitting the request is executed using at least one virtual channel of the one or more virtual channels, the at least one virtual channel communicatively coupling privileged software and the virtual machine, wherein the privileged software configures the physical display engine responsive to receiving the request using the at least one virtual channel.

4. The method of claim 1, wherein the allocation includes a configuration of the physical display engine to generate the surface as a composite of the one or more display surfaces from the virtual machine and one or more second display surfaces from at least a second virtual machine.

5. The method of claim 1, wherein the allocation includes a configuration of the physical display engine to generate the surface as a composite of at least a first surface of the one or more display surfaces and at least a second surface of the one or more display surfaces.

6. The method of claim 1, wherein one or more of the receiving of the data or the transmitting the image data is performed at least using a kernel mode driver of the virtual machine.

7. The method of claim 1, wherein the one or more virtual channels correspond to one or more virtual network adapters assigned to the virtual machine.

8. The method of claim 1, wherein the receiving the data comprises receiving the data using a first channel of the one or more virtual channels communicatively coupling the virtual machine and privileged software, and the transmitting the image data comprises transmitting the image data using a second channel of the one or more virtual channels communicatively coupling the virtual machine and the physical display engine.

9. A processor comprising:
one or more circuits to store, using one or more virtual channels allocated to a virtual machine, image data representing one or more display surfaces in memory assigned to the one or more display surfaces in a virtual address space of the virtual machine, wherein a physical display engine fetches the image data from the memory using the virtual address space and scans-out a surface corresponding to the one or more display surfaces to a display.

10. The processor of claim 9, wherein the one or more circuits are further to request an allocation of the one or more display surfaces to the virtual machine, the allocation including one or more of:
configuring the physical display engine to fetch the image data from the memory using the virtual address space;
configuring raster timings the physical display engine uses to scan-out the surface; or
configuring a resolution the physical display engine uses to scan-out the surface.

11. The processor of claim 9, the one or more circuits are further to configure the physical display engine to generate the surface as a composite of the one or more display surfaces from the virtual machine and one or more second display surfaces from at least a second virtual machine.

12. The processor of claim 9, wherein the one or more circuits are further to configure the physical display engine to generate the surface as a composite of at least a first surface of the one or more display surfaces and at least a second surface of the one or more display surfaces.

13. The processor of claim 9, wherein the storing the image data is performed at least using a kernel mode driver of the virtual machine.

14. The processor of claim 9, wherein the one or more virtual channels correspond to one or more virtual network adapters assigned to the virtual machine.

15. The processor of claim 9, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing real-time streaming;
a system for performing deep learning operations;
a system implemented using an edge device;
a system implemented using a robot;
a system for performing conversational AI operations;
a system for presenting at least one of virtual reality content, augmented reality content, or mixed reality content;
a system for generating synthetic data;
a system implemented at least partially in a data center; or
a system implemented at least partially using cloud computing resources.

16. A system comprising:
one or more processing units to perform operations including:
receiving, over one or more virtual channels allocated to a virtual machine, a request for an allocation of one or more display surfaces to the virtual machine; and
based at least on the receiving of the request, configuring a physical display engine to fetch image data representing the one or more display surfaces from memory assigned to the one or more display surfaces in a virtual address space of the virtual machine.

17. The system of claim 16, wherein the configuring further includes one or more of:
configuring raster timings the physical display engine uses to scan-out the surface;
configuring a resolution the physical display engine uses to scan-out the surface; or
configuring the physical display engine to generate the surface as a composite of at least a first surface of the one or more display surfaces and at least a second surface of the one or more display surfaces.

18. The system of claim 16, wherein the operations are performed using one or more of a privileged virtual machine or trusted microcode.

19. The system of claim 16, further comprising:
receiving, using one or more second virtual channels allocated to a second virtual machine, a second request for a second allocation of one or more second display surfaces to the second virtual machine; and
based at least on the receiving of the second request, configuring the physical display engine to fetch second image data representing the one or more second display surfaces from memory assigned to the one or more second display surfaces in a second virtual address space of the second virtual machine.

20. The system of claim 16, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing real-time streaming;
a system for performing collaborative content creation for 3D assets;
a system for performing deep learning operations;
a system implemented using an edge device;
a system implemented using a robot;
a system for presenting at least one of virtual reality content, augmented reality content, or mixed reality content;
a system for performing conversational AI operations;
a system for generating synthetic data;
a system implemented at least partially in a data center; or
a system implemented at least partially using cloud computing resources.
